(19) United States
(12) Patent Application Publication
(10) Pub. No.: US 2013/0266885 A1
(43) Pub. Date: Oct. 10, 2013

(54) FUEL CELL STACK AND FUEL CELL COMPRISING THE SAME

(71) Applicant: SAMSUNG ELECTRONICS CO., LTD., (US)

(72) Inventors: Jung-seok YI, Seoul (KR); Ji-rae KIM, Seoul (KR); Tae-won SONG, Yongin-si (KR)

(73) Assignee: SAMSUNG ELECTRONICS CO., LTD., Suwon-si (KR)

(21) Appl. No.: 13/679,560

(22) Filed: Nov. 16, 2012

(30) Foreign Application Priority Data
Jan. 19, 2012 (KR) 10-2012-0006410

(51) Int. Cl. H01M 8/24

(52) U.S. Cl. CPC H01M 8/241
USPC 429/465

(57) ABSTRACT

A fuel cell stack includes a membrane electrode assembly, plates on the membrane electrode assembly, and gaskets between the plates, where the membrane electrode assembly includes an electrolyte membrane-electrode including an electrolyte membrane between first and second electrodes thereof, and gas diffusion layers in contact with the first and second electrodes, where the gaskets are in contact with the plates and surround the membrane electrode assembly, where a ratio of change in compressibility of the gaskets is in a range from 0.5 times to 1.5 times a ratio of change in compressibility of the gas diffusion layers at a same compressibility, where a compressibility is a ratio of a reduced thickness to an initial thickness, and where the ratio of change in compressibility is defined by Equation 1 below: <Equation 1> Ratio of change in compressibility=ΔP/Δt, where ΔP denotes a pressure change, and Δt denotes a thickness change.

### CROSS-REFERENCE TO RELATED APPLICATIONS

This application claims priority to Korean Patent Application No. 10-2012-0006410, filed on Jan. 19, 2012, and all the benefits accruing therefrom under 35 U.S.C. §119, the content of which in its entirety is herein incorporated by reference.

### BACKGROUND

1. Field

The present disclosure relates to a fuel cell stack and a fuel cell including the fuel cell stack.

2. Description of the Related Art

Recently, as concerns about environmental problems related to fossil fuel and depletion of energy sources have increased, fuel cells applicable to vehicles and consumer electronic devices have received much attention.

A fuel cell is an energy converting device that converts energy stored in a fuel into electricity through a chemical reaction of the fuel and an oxydizable gas. Fuel cells may be classified into solid oxide fuel cells which use solid oxides and operate at a temperature around 1000° C., molten carbonate electrolyte fuel cells which operate at a temperature in a range from 500° C. to 700° C., phosphoric acid electrolyte fuel cells which operate at a temperature around 200° C., alkaline electrolyte fuel cell which operate at a temperature in a range of room temperature to about 100° C. or lower and polymer electrolyte fuel cells, for example.

The polymer electrolyte fuel cells include proton exchange membrane fuel cells (“PEMFC”s) using hydrogen gas as a fuel, direct methanol fuel cells (“DMFC”s) using a liquid methanol as a direct fuel and providing the fuel into an anode, and the like. The polymer electrolyte fuel cells are alternative energy sources of fossil energy as the polymer electrolyte fuel cells have high power density and efficiency of energy conversion. Also, the polymer electrolyte fuel cells may be operated at a room temperature and may be miniaturized and sealed, and thus, may be used widely for vehicles, residential power generation systems, mobile communication devices, medical instruments, military equipment, or space equipment.

A PEMFC is a power generating system for producing direct current from a chemical reaction of hydrogen and oxygen. The PEMFC has a structure including a hydrogen ion exchange membrane between an anode and a cathode.

The hydrogen ion exchange membrane includes a solid polymer material such as Nafion®, which has good hydrogen ion conductivity and through which a reduced amount of a non-reactive gas or fuel passes to the cathode. Each of the anode and the cathode may include a supporting layer for providing reactive gas or liquid and catalysts where an oxidation/reduction of the reactive gas occurs.

The PEMFC having the structure described above converts hydrogen molecules into hydrogen ions and electrons by oxidation occurring in the anode as the reactive gas hydrogen is supplied. Here, the hydrogen ions are passed to the cathode through the hydrogen ion exchange membrane.

In contrast, oxygen molecules are converted to oxygen ions by reduction as receiving electrons, and the oxygen ions are converted to water molecules by reacting with the hydrogen ions from the anode.

Gas diffusion layers (“GDL”s) of the PEMFC are included in a membrane electrode assembly (“MEA”).

The DMFCs have substantially the same structure as the PEMFCs described above, except that hydrogen ions, electrons and carbon dioxide are produced by oxidation of methanol in a liquid state with the help of a catalyst, instead of using hydrogen as a reacting gas. The cell efficiency of the DMFCs is less than that of the PEMFC, and the DMFC may be used in portable electronic devices since a fuel injected therein is in a liquid state.

Generally, fuel cells of a stack type include a plurality of unit cells that are stacked and connected to each other. Also, gaskets for sealing a MEA are generally installed in the fuel cells since hydrogen is used as a reactive gas.

During a long-term operation of the fuel cells, a change in the thickness of the MEA may occur due to a property change of a material of the MEA. Thus, changes in the thickness of gaskets and the thickness of a stack may occur due to the change in the thickness of the MEA. Therefore, a change in the pressure applied to the MEA, the gaskets, and the stack occurs and the durability of the stack may be affected.

### SUMMARY

Provided is a fuel cell stack including gaskets with improved durability.

Provided is a fuel cell including the fuel cell stack.

Additional features will be set forth in part in the description which follows and, in part, will be apparent from the description, or may be learned by practice of the embodiments described herein.

According to an embodiment of the invention, a fuel cell stack includes membrane electrode assembly (“MEA”) including an electrolyte membrane-electrode including a first electrode, a second electrode and an electrolyte membrane which is interposed between the first and second electrodes and contacts a first surface of each of the first and second electrodes; and gas diffusion layers (“GDL”s) which are disposed in contact with a second surface of each of the first and second electrodes; plates which are disposed on surfaces of the MEA; and gaskets which are disposed between the plates, where the gaskets are in contact with the plates and surround the MEA, where a ratio of change in compressibility of the gaskets is in a range from about 0.5 times a ratio of change in compressibility of the GDLs to about 1.5 times the ratio of change in compressibility of the GDLs at a same compressibility, where a compressibility is a ratio of a reduced thickness with respect to an initial thickness, and the ratio of change in compressibility is defined by Equation 1 below:

Ratio of change in compressibility=ΔP/Δt, <Equation 1>

where ΔP denotes a pressure change, and Δt denotes a thickness change.

According to another embodiment of the invention, a fuel cell includes a supplier which supplies fuel and air; a MEA including an electrolyte membrane-electrode including a first electrode, a second electrode, and an electrolyte membrane which is interposed between the first and second electrodes and contacts a first surface of each of the first and second electrodes; and GDLs which are disposed in contact with a second surface of each of the first and second electrodes; plates which are disposed on surfaces of the MEA; and gaskets which are disposed between the plates, where the gaskets contact the plates and surround the MEA, where a ratio of change in compressibility of the gaskets is in a range from about 0.5 times a ratio of change in compressibility of the GDLs to about 1.5 times the ratio of change in compressibility of the GDLs at a same compressibility, a compressibility is a ratio of a reduced thickness to an initial thickness, and the ratio of change in compressibility is defined by Equation 1 below:

Ratio of change in compressibility=ΔP/Δt, <Equation 1>

where ΔP denotes a pressure change, and Δt denotes a thickness change.

### BRIEF DESCRIPTION OF THE DRAWINGS

These and/or other features will become apparent and more readily appreciated from the following description of the embodiments, taken in conjunction with the accompanying drawings of which:

FIG. 1 is a block diagram showing an embodiment of a fuel cell according to the invention;

FIG. 2 is a graph showing change in thickness of gaskets according to a ratio of change in compressibility of the gaskets; and

FIG. 3 is a graph showing results of thickness changes versus force applied to a material (has same contact area) in Evaluation Example 1.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, embodiments of the invention will be described in further detail with reference to the accompanying drawings.

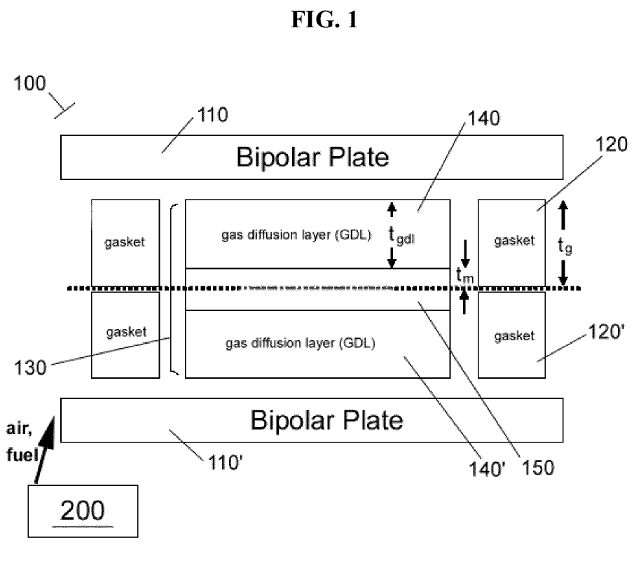

FIG. 1 is a block diagram showing an embodiment of a fuel cell stack 100 according to the invention.

As illustrated in FIG. 1, an embodiment of the fuel cell stack 100 includes a membrane electrode assembly (“MEA”) 130 including an electrolyte membrane-electrode 150 including a first electrode, a second electrode and an electrolyte membrane which is interposed between the first and second electrodes and contacts a first surface, e.g., inner surface, of each of the first and second electrodes, and gas diffusion layers (“GDL”s) 140 and 140′ which are disposed in contact with a second surface, e.g., outer surface, of each of the first and second electrodes, plates 110 and 110′ which are respectively disposed on surfaces of the MEA 130, and gaskets 120 and 120′ which are disposed between the plates 110 and 110′. In such an embodiment, the gaskets 120 and 120′ are in contact with the plates 110 and 110′ and surround the MEA 130. In such an embodiment, a ratio of change in compressibility of the gaskets 120 and 120′ is in a range from about 0.5 times a ratio of change in compressibility of the GDLs 140 and 140′ to about 1.5 times the ratio of change in compressibility of the GDLs 140 and 140′ under the same conditions. Here, the compressibility is defined as a ratio of a reduction in thickness with respect to an initial thickness. In an embodiment, the ratio of change in compressibility is defined by Equation 1 below:

Ratio of change in compressibility=ΔP/Δt <Equation 1>

In Equation 1, ΔP denotes a pressure change, and Δt denotes a thickness change. Here, a ratio of change in compressibility of a gasket may be represented by ΔP_{g}/Δt_{g}, and a ratio of change in compressibility of a GDL may be represented by ΔP_{gdl}/Δt_{gdl}.

For example, when a thickness of a certain material is reduced from an initial value of 100 to a final value of 80, a compressibility of the material is (100−80)/100=0.2.

The compressibility of the gaskets in the fuel cell stack 100 may be in a range from about 0.05 to about 0.95. In an embodiment, the compressibility of the gaskets in the fuel cell stack 100 may be in a range, for example, from about 0.1 to about 0.9, from about 0.1 to about 0.8, from about 0.1 to about 0.7 from about 0.1 to about 0.5, or from about 0.1 to about 0.4. The compressibility of the GDLs in the fuel cell stack 100 may be in a range from about 0.05 to about 0.95. In an embodiment, compressibility of the GDLs in the fuel cell stack 100 may be in a range, for example, from about 0.1 to about 0.9, from about 0.1 to about 0.8, from about 0.1 to about 0.7 from about 0.1 to about 0.5, or from about 0.1 to about 0.4.

The ratio of change in compressibility of gasket indicates a ratio of a pressure change applied to the gaskets with respect to the thickness change of the gaskets. The ratio of change in compressibility of GDLs indicates a pressure change applied to the GDLs with respect to the thickness change of the GDLs. A thickness change according to a pressure change of a material having a high elasticity, such as rubber, is large, and thus, a ratio of change in compressibility is low. A thickness change according to a pressure change of a material having a low elasticity, such as a Teflon® sheet, is small, and thus, a ratio of change in compressibility is high. The ratio of change in compressibility may change according to the compressibility.

When a thickness of the electrolyte membrane changes during a long-term operation of the fuel cell stack 100, or when a difference between the ratio of change in compressibility of the GDLs and the ratio of change in compressibility of the gaskets is substantially large, pressures applied to the GDLs and the gaskets may become different, and thus, the durability of the stack may decline.

When a gasket includes a material (hereinafter, “gasket material”) having a high elasticity and a ratio of change in compressibility of the material of the gasket is about 0.1 times less than a ratio of change in compressibility of a material of the GDL (hereinafter, “GDL material”), as a thickness of the electrolyte membrane becomes thinner during the long-term operation of the fuel cell stack 100, a thickness of a gasket may become thinner. Thus, a pressure applied to a MEA is substantially maintained or slightly decreased. However, since the thickness of the gasket is substantially reduced, a thickness of the entire stack comprising a number of unit cells reduces, and a pressure applied to the entire stack by end plates, which are only disposed at both ends of the entire stack, is substantially reduced, and thus, a pressure applied to the entire stack may not be substantially constant.

When a gasket material has a very low elasticity and a ratio of change in compressibility of the gasket material is 2 times greater than a ratio of change in compressibility of a GDL material, although a thickness of the electrolyte membrane becomes thinner during the long-term operation process, a thickness of a gasket is substantially maintained. Thus, a pressure applied to a MEA is relatively significantly reduced. Therefore, a performance of the MEA may be impaired.

Accordingly, in an embodiment, the ratio of change in compressibility of the gasket material and the ratio of change in compressibility of the GDL material are substantially similar in the fuel cell stack, and the pressures applied to the GDLs and the gaskets may become substantially the same as each other such that the durability of the stack is substantially improved.

In an embodiment, the ratio of change in compressibility of the gasket in the fuel cell stack may be in a range of about 0.7 times the ratio of change in compressibility of the GDL to about 1.3 times the ratio of change in compressibility of the GDL. In an alternative embodiment, the ratio of change in compressibility of the gasket in the fuel cell stack may be in a range of about 0.8 times the ratio of change in compressibility of the GDL to about 1.2 times the ratio of change in compressibility of the GDL. In another alternative embodiment, the ratio of change in compressibility of the gasket in the fuel cell stack may be in a range of about 0.9 times the ratio of change in compressibility of the GDL to about 1.1 times the ratio of change in compressibility of the GDL. In an embodiment, the ratio of change in compressibility of the gasket may be substantially the same with the ratio of change in compressibility of the GDL.

When a constant force is applied to the MEA 130 and the gaskets 120 and 120′ by the plates 110 and 110′, the applied force is divided to the MEA and the gaskets by a ratio of change in compressibility of the GDLs 140 and 140′ and a ratio of change in the gaskets 120 and 120′ at the ends of the MEA 130, and a pressure applied to the MEA 130 and a thickness of the gasket 120, for example, may be changed. More particularly, a relationship therebetween may be described quantitatively as below.

A pressure property of the MEA (P_{MEA}), a pressure property of the gasket (P_{g}), and an entire force (F) applied to the plate in the fuel cell stack illustrated in FIG. 1 may be defined by equations below.

P_{MEA}=a_{gdl}t_{gdl}+b_{gdl}

P_{g}=a_{g}t_{g}+b_{g}

F=P_{MEA}A_{MEA}+P_{g}A_{g}

t_{g}=t_{gdl}+tₘ

In the equations above, a_{gdl} denotes a proportional factor of the GDL, b_{gdl} denotes an intercept of the GDL, a_{g} denotes a proportional factor of the gasket, b_{g} denotes an intercept of the gasket, and A_{MEA} denotes a cross-sectional area of the MEA, A_{g} denotes a cross-sectional area of the gasket. In such equations, t_{gdl} denotes a thickness of the GDLs 104 and 140′, t_{g} denotes a thickness of the gaskets 120 and 120′ and tₘ denotes a thickness of the electrolyte membrane-electrode 150, as shown in FIG. 1.

During a long-term operation process of the fuel cell stack 100, when a membrane thickness of the electrolyte membrane-electrode 150 reduces from an initial thickness tₘ to a final thickness t^{f}ₘ, a final thickness of the GDL (t^{f}_{gdl}) and a final pressure applied to the MEA (P^{f}_{MEA}) may be calculated using equations below.

$${t}_{gdl}^{f} = \frac{F - ( {b}_{gdl} {A}_{MEA} + {b}_{g} {A}_{g} + {a}_{g} {t}_{m}^{f} {A}_{g} )}{{a}_{gdl} {A}_{MEA} + {a}_{g} {A}_{g}}$$

$${P}_{MEA}^{f} = {a}_{gdl} {t}_{gdl}^{f} + {b}_{gdl}$$

Using the equations above, a change in thickness of a gasket may be calculated.

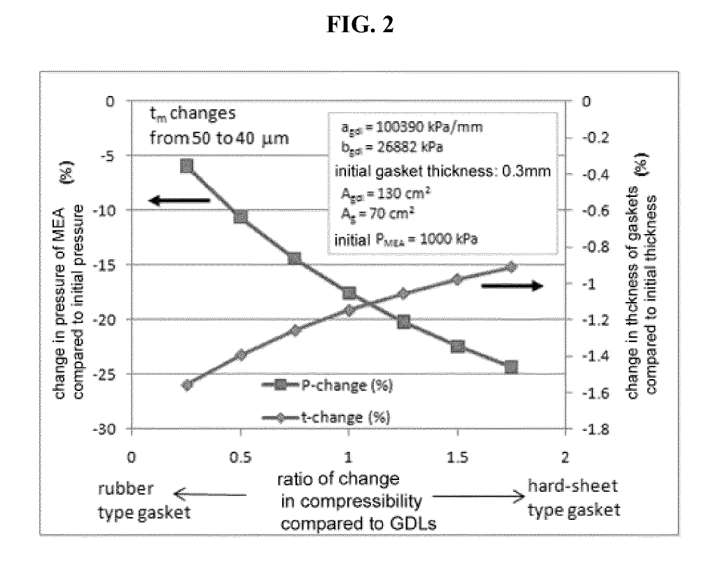

The change in thickness of the gasket and the change in pressure applied to the MEA according to the ratio of change in compressibility of the gasket due to a reduction of the thickness of the electrolyte membrane-electrode 150 from about 50 micrometers (μm) to about 40 micrometers (μm) are calculated from the equations above as shown in FIG. 2.

As shown in FIG. 2, when the ratio of change in compressibility of the gaskets 120 and 120′ is substantially higher than the ratio of change in compressibility of the GDLs 140 and 140′, the change in thickness of the gaskets 120 and 120′ become substantially less even when the thickness of the electrolyte membrane-electrode 150 is reduced, and thus, the pressure applied to the MEA 130 is substantially reduced compared to the initial pressure. When the ratio of change in compressibility of the gaskets 120 and 120′ is substantially lower than the ratio of change in compressibility of the GDLs 140 and 140′, the change in thickness of the gaskets 120 and 120′ become significant as the thickness of the electrolyte membrane-electrode 150 is reduced, and thus, the thickness of the entire stack including a number of unit cells is reduced and the pressure applied to the entire stack by the end plates may be substantially increased such that the entire stack may not be maintained. In an embodiment, the durability of the fuel cell stack may be improved by selecting a material of the gaskets 120 and 120′ that has a ratio of change in compressibility similar to the ratio of change in compressibility of the MEA 130, more specifically GDLs 140 and 140′.

The electrodes included in the electrolyte membrane-electrode 150 may include a catalyst layer and additional layers such as a microporous layer. Hereinafter, for convenience of calculation, an embodiment where the GDLs 140 are separated from the electrolyte membrane-electrode 150 as shown in FIG. 1 will be described.

In an embodiment of the fuel cell stack, when the membrane thickness of an electrolyte membrane-electrode defined by Equation 2 below is reduced by 20%, the thickness of the gasket may be reduced by a percentage in a range from about 1% to about 1.4% with respect to the initial thickness. In another embodiment, the thickness of the gasket may be reduced by a percentage in a range from about 1.1% to about 1.3% with respect to the initial thickness.

Membrane thickness of electrolyte membrane/electrode (tₘ)=Thickness of gasket (t_{g})−Thickness of GDL (t_{gdl}) <Equation 2>

In an embodiment of the fuel cell stack, when the membrane thickness of an electrolyte membrane-electrode defined by Equation 2 above is reduced by a percentage of about 20%, the pressure applied to the MEA may be reduced by a percentage in a range from about 10% to about 22% with respect to the initial pressure. In another embodiment, the pressure applied to the MEA may be reduced by a percentage in a range from about 15% to about 20% with respect to the initial pressure.

In an embodiment of the fuel cell stack, the gasket may include two materials having different ratios of change in compressibility, e.g., a material having a high ratio of change in compressibility and a material having a low ratio of change in compressibility. In an embodiment, the gasket may include a mixture of a material having a high ratio of change in compressibility and a material having a low ratio of change in compressibility. In another embodiment, the gasket may include a composite of a material having a high ratio of change in compressibility and a material having a low ratio of change in compressibility, but the invention is not limited thereto. In an embodiment, the ratio of change in compressibility of the gasket is in a range of about 0.5 times the ratio of change in compressibility of the GDL to about 1.5 times of the ratio of change in compressibility of the GDL, while the material is not limited to any kind of particular material, a mixture ratio thereof or a resultant shape.

In an embodiment, a ratio of change in compressibility of the material having a high ratio of change in compressibility may be greater than or equal to about 1.7 times the ratio of change in compressibility of a GDL material. In another embodiment, a ratio of change in compressibility of the material having a high ratio of change in compressibility may be about greater than or equal to about 2.0 times the ratio of change in compressibility of the GDL material.

In an embodiment, a ratio of change in compressibility of the material having a low ratio of change in compressibility may be equal to or less than about 0.3 times the ratio of change in compressibility of the GDL material. In another embodiment, a ratio of change in compressibility of the material having a low ratio of change in compressibility may be equal to or less than about 0.1 times the ratio of change in compressibility of the GDL material.

The material having a high ratio of change in compressibility may include at least one selected from the group consisting of Teflon®, polytetrafluoroethylene, carbon paper, carbon cloth, carbon felt, carbon fiber, glass fiber, Kapton®, polyimide, phenolic resin and acrylic resin, for example, but not being limited thereto. In an embodiment, any material having a low ratio of change in thickness by an applied pressure known in the field of the art may be used.

The material having a low ratio of change in compressibility may include at least one selected from the group consisting of ethylene propylene rubber, butyl rubber, silicon rubber, and fluoro-rubber, for example, but not being limited thereto. In an embodiment, any material having a high ratio of change in thickness by an applied pressure known in the field of the art may be used.

The material of the gasket may be substantially the same material as the GDL material. In one embodiment, for example, the gasket includes the same material as the GDL material, and a sealing performance is substantially improved. In an embodiment, the gasket may include a mixture of the same material as the GDL material and another material. In one embodiment, for example, the material included in the gasket may be a liquid material impregnated in the GDL material impregnated with a liquid phase material. In an embodiment, the gasket may include a material with a sealing property and a high ratio of change in compressibility. In another embodiment, the gasket may include a material with an excellent sealing property and a low ratio of change in compressibility. In one embodiment, for example, the material of the gasket may be a mixture of a liquid rubber and a carbonaceous material.

An embodiment of a fuel cell according to the invention includes the fuel cell stack.

In an embodiment, the fuel cell includes a supplier 200 which supplies fuel and air; a MEA 130 including an electrolyte membrane-electrode 150 including a first electrode, a second electrode and an electrolyte membrane which is interposed between the first and second electrodes and contacts a first surface (e.g., an inner surface) of each of the first and second electrodes; and GDLs 140 and 140′ which are disposed in contact with a second surface (e.g., outer surface) of each of the first and second electrodes; plates 110 and 110′ which are disposed on surfaces of the MEA 130; and gaskets 120 and 120′ which are disposed between the plates 110 and 110′, contact the plates 110 and 110′, and surround the MEA 130, where a ratio of change in compressibility of the gaskets 120 and 120′ is in a range of about 0.5 times a ratio of change in compressibility of the GDLs 140 and 140′ to about 1.5 times the ratio of change in compressibility of the GDLs 140 and 140′ at a same compressibility, and the compressibility is a ratio of a reduced thickness to an initial thickness. The ratio of change in compressibility is defined by Equation 1 below:

Ratio of change in compressibility=ΔP/Δt <Equation 1>

In Equation 1, ΔP is a pressure change, and Δt is a thickness change.

In an embodiment of the fuel cell, a ratio of change in compressibility of the gaskets may be in a range of about 0.7 times the ratio of change in compressibility of the GDLs 140 and 140′ to about 1.3 times the ratio of change in compressibility of the GDL.

In an embodiment of the fuel cell, the ratio of compressibility of the gaskets may be in a range from about 0.1 to about 0.9. In such an embodiment, the ratio of compressibility of the gaskets may be in a range, for example, from about 0.1 to about 0.8, from about 0.1 to about 0.7, from about 0.1 to about 0.5, or from about 0.2 to about 0.4. In an embodiment of the fuel cell, the ratio of compressibility of the GDLs may be in a range from about 0.1 to about 0.9. In such an embodiment, the ratio of compressibility of the GDLs may be in a range, for example, from about 0.1 to about 0.8, from about 0.1 to about 0.7, from about 0.1 to about 0.5, or from about 0.2 to about 0.4.

In an embodiment of the fuel cell, the membrane thickness of an electrolyte membrane-electrode defined by Equation 2 below is reduced by a percentage of about 20%, and the thickness of the gasket may be reduced by a percentage in a range from about 1% to about 1.4%. In such an embodiment, for example, the thickness of the gasket may be reduced by a percentage in a range from about 1.1% to about 1.3%.

Membrane thickness of electrolyte membrane-electrode (tₘ)=Thickness of gasket (t_{g})−Thickness of GDL (t_{gdl}) <Equation 2>

In an embodiment of the fuel cell, the membrane thickness of an electrolyte membrane-electrode defined by Equation 2 above is reduced by a percentage of about 20%, the pressure applied to the MEA may be reduced by a percentage in a range from about 10% to about 22%, and the pressure applied to the MEA may be reduced by a percentage in a range from about 15% to about 20%.

In an embodiment of the fuel cell, the first electrode may be a cathode, and the second electrode may be an anode. In such an embodiment, when air including oxygen and gas including hydrogen, which is a fuel, are respectively supplied to the cathode and the anode from the supplier, electricity is generated from a reversed reaction of electrolysis of water that occurs in the electrolyte membrane.

Hereinafter, an embodiment of a method of manufacturing the fuel cell will be described in detail.

First, an electrolyte membrane is prepared.

Any electrolyte membrane known in the art may be used for the electrolyte membrane included in the electrolyte membrane-electrode 150. In an embodiment, a polybenzimidazole electrolyte membrane, a polybenzoxazine-polybenzimidazole copolymer electrolyte membrane, a polytetrafluoroethylene (“PTFE”) porous membrane, a fluoro sulfonic acid based membrane, a sulfonic acid based hydrocarbon membrane or an electrolyte membrane disclosed in US 2007/275285 A. In an embodiment, the electrolyte membrane contains water to have improved ion conductivity. In an embodiment, a molecular weight of the electrolyte membrane may have a number average molecular weight in a range of about 1,000 to about 1,000,000, and a weight average molecular weight in a range of about 10,000 to about 1,000,000. In such an embodiment, a thickness of the polymer electrolyte membrane may be in a range of about 10 μm to about 300 μm.

In an embodiment, a proton conductor may be further impregnated in the electrolyte membrane. In such an embodiment, the proton conductor may be a polyphosphoric acid, phosphonic acid (H₃PO₃), orthophosphoric acid (H₃PO₄), pyrophosphoric acid (H₄P₂O₇), triphosphoric acid (H₅P₃O₁₀), or metaphosphoric acid or derivatives thereof, for example, but not being limited thereto. In an embodiment, a concentration of the proton conductor may be in a range from about 80 to about 98 weight %. In an embodiment, the concentration of the proton conductor may be for example, about 80 weight %, about 90 weight %, about 95 weight %, or about 98 weight %.

Next, a catalyst layer is prepared.

An electrode included in the electrolyte membrane-electrode 150 includes the catalyst layer and may further include other layers such as a microporous layer. The catalyst layer may be manufactured by mixing a catalyst and a binder with an appropriate solvent.

The catalyst layer includes the catalyst and the binder. For the catalyst, an alloy or a mixture of platinum and one or more types of metal selected from the group consisting of platinum (Pt), gold, palladium, rhodium, iridium, ruthenium, tin, molybdenum, cobalt and chrome may be used, or the catalyst may be a supported catalyst having a catalyst metal impregnated in a carbon-based carrier. In an embodiment, at least one catalyst metal selected from the group consisting of Pt, platinum-cobalt (Pt—Co), and platinum-ruthenium (Pt—Ru), or a supported catalyst of which the catalyst metal is impregnated in a carbon-based carrier may be used.

For the binder, one or more selected from the group consisting of poly(vinylidene fluoride), polytetrafluoroethylene, tetrafluoroethylene-hexafluoroethlyene copolymer and perfluoroethylene may be used. A concentration of the binder is in a range of about 0.001 parts per weight to about 0.5 parts per weight based on 1 part per weight of the catalyst. In an embodiment, the concentration of the binder is in the range above, and a binding strength of the catalyst layer to a supporter is thereby improved.

Then, a GDL is prepared.

In an embodiment, the GDL 140 includes a conductive porous carbon substrate. The conductive porous carbon substrate is a carbon substrate having conductivity and porosity and includes various carbon substrates such as, for example, carbon paper, carbon felt and carbon cloth. Any carbon substrate having conductivity and porosity and is available in the field of the art may be used for the carbon substrate. The carbon substrate may be any carbon substrate that is commercially available. In one embodiment, for example, the carbon substrate may include resin carbonized products settled on carbon fibers.

Electrodes including the catalyst layer may be disposed on both surfaces of the electrolyte membrane. A structure including the electrodes and the electrolyte membrane may be formed by binding at a high temperature and with a high pressure, and a MEA may be formed by binding GDL onto the resultant structure. In such an embodiment, the temperature may be increased to a value where the electrolyte membrane is softened to perform the binding, and the pressure may be applied to a range of about 0.1 tons per square centimeter (ton/cm²) to about 3 tons per square centimeter (ton/cm²), particularly to about 1 ton/cm².

Subsequently, a single fuel cell is prepared by disposing the gaskets described above around the MEA and disposing bipolar plates next to opposite surfaces thereof. The bipolar plates have grooves for fuel supply and operate as a current collector.

A fuel cell stack is prepared by stacking a plurality of fuel cells, disposing end plates on both sides thereof, and inducing a pressure via a constant force. A fuel cell is prepared by connecting a supply source to supply fuel and air to the fuel cell stack. In an embodiment, fuel cell stack 100 of FIG. 1 includes a plurality of fuel cells or unit cells although only a single fuel cell unit for convenience of illustration is shown in the fuel cell stack of FIG. 1.

In an embodiment, the fuel cell may be used as a polymer electrolyte membrane fuel cell, but use of the fuel cell in not limited thereto.

Hereinafter, an exemplary experiment showing a ratio of change in compressibility of GDL (Reference Example 1) and gaskets (Comparative Example 1, Comparative Example 2 and Example 1) will be described in detail.

### Reference Example 1

Carbon paper (Sigracet® 35BC, SGL carbon) for a GDL was obtained and used.

### Comparative Example 1

Rubber (fluoroelastomer (“FKM”) rubber, Dong-A Hwa Sung Co. LTD) for a gasket was obtained and used after molding it into a sheet form.

### Comparative Example 2

Teflon® sheet (Nitoflon®, Nitto Denko) for a gasket was obtained and was used as itself.

### Example 1

Liquid rubber (FKM rubber, Dong-A Hwa Sung Co. LTD) was injected in a GDL (Sigracet® 35AA, SGL carbon), and thus a gasket formed of the GDL impregnated with liquid rubber was manufactured.

### Evaluation Example 1

### Evaluation of a Ratio of Change in Compressibility

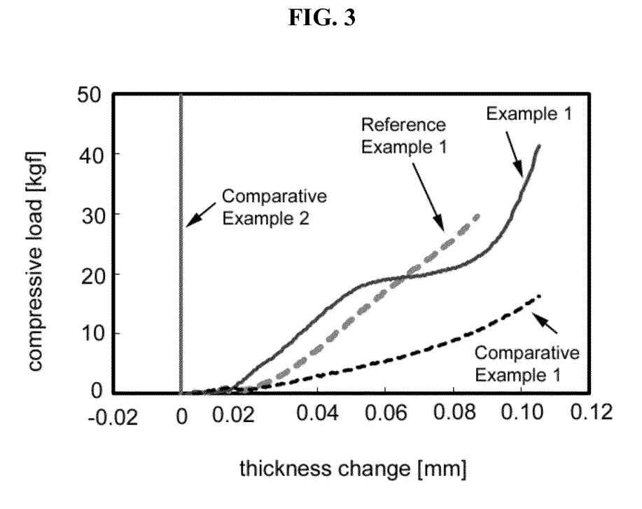

An amount of compression according to a compressive load on various materials was measured, as shown in FIG. 3. Evaluation conditions were as follows.

After measuring an initial thickness of a sample, a thickness change of the sample was measured while subjecting the sample to a certain force applied. In such experiment, the contact area of each sample is substantially identical to each other such that the change of force applied may be substantially identical to the change of pressure applied to each sample. By increasing a pressure in a regular interval and measuring the thickness change, a pressure change per thickness change was measured.

As shown in FIG. 3, Comparative Example 2 shows a nearly infinite increase of the ratio of change in compressibility with respect to the ratio of change in compressibility of Reference Example 1 at about 0.06 millimeter (mm) of the thickness change, and Comparative Example 1 shows about 0.27 times the ratio of change in compressibility of Reference Example 1. As shown in FIG. 3, Example 1 has the ratio of change in compressibility in a range from a ratio substantially the same as the ratio of change in compressibility to about 1.02 times the ratio of change in compressibility of Reference Example 1.

As described above, according to the one or more embodiments of the invention, deterioration of durability due to a thickness change of a MEA occurring during an operation process of a fuel cell may be effectively prevented.

According to one or more embodiments of the invention as described herein, durability of a fuel cell stack may be improved by using a gasket material that has a degree of thickness change substantially the same as a degree of thickness change a GDL material under a similar pressure.

While the invention has been particularly shown and described with reference to a few embodiments thereof, it will be understood by those of ordinary skill in the art that various changes in form and details may be made therein without departing from the spirit and scope of the invention as defined by the following claims.

What is claimed is:

1. A fuel cell stack comprising:
a membrane electrode assembly, wherein the membrane electrode assembly comprises:
an electrolyte membrane-electrode comprising:
a first electrode;
a second electrode; and
an electrolyte membrane which is interposed between the first and second electrodes and contacts a first surface of each of the first and second electrodes; and
a plurality of gas diffusion layers which are disposed in contact with a second surface of each of the first and second electrodes;
a plurality of plates which are disposed on a surface of the membrane electrode assembly; and
a plurality of gaskets which are disposed between the plates, wherein the gaskets are in contact with the plates and surround the membrane electrode assembly,
wherein a ratio of change in compressibility of the gaskets is in a range from about 0.5 times a ratio of change in compressibility of the gas diffusion layers to about 1.5 times the ratio of change in compressibility of the gas diffusion layers, at a same compressibility,
wherein a compressibility is a ratio of a reduced thickness with respect to an initial thickness, and
wherein the ratio of change in compressibility is defined by Equation 1 below:
Ratio of change in compressibility=ΔP/Δt, <Equation 1>
wherein ΔP denotes a pressure change, and Δt denotes a thickness change.

2. The fuel cell stack of claim 1, wherein
the ratio of change in compressibility of the gaskets is in a range from about 0.7 times the ratio of change in compressibility of the gas diffusion layers to about 1.3 times the ratio of change in compressibility of the gas diffusion layers.

3. The fuel cell stack of claim 1, wherein the compressibility of each of the gas diffusion layers and the gaskets is in a range from about 0.01 to about 0.5.

4. The fuel cell stack of claim 1, wherein a thickness of the gaskets is reduced by a percentage in a range from about 1% to about 1.4% when a membrane thickness of the electrolyte membrane-electrode defined by Equation 2 below is reduced by about 20%:
Membrane thickness of an electrolyte membrane-electrode (tₘ)=Thickness of a gasket (t_{g})−Thickness of a gas diffusion layer (t_{gdl}) <Equation 2>.

5. The fuel cell stack of claim 4, wherein the thickness of the gasket is reduced by a percentage in a range from about 1.1% to about 1.3%.

6. The fuel cell stack of claim 1, wherein a pressure applied to the membrane electrode assembly is reduced by a percentage in a range from about 10% to about 22% when a membrane thickness of the electrolyte membrane-electrode defined by Equation 2 below is reduced by a percentage of about 20%:
Membrane thickness of an electrolyte membrane-electrode (tₘ)=Thickness of a gasket (t_{g})−Thickness of a gas diffusion layer (t_{gdl}) <Equation 2>.

7. The fuel cell stack of claim 6, wherein the pressure applied to the membrane electrode assembly is reduced by a percentage in a range from about 15 to about 20%.

8. The fuel cell stack of claim 1, wherein
the gaskets comprise:
a material having a higher ratio of change in compressibility than the ratio of change in compressibility of the gas diffusion layers; and
a material having a lower ratio of change in compressibility than the ratio of change in compressibility of the gas diffusion layers.

9. The fuel cell stack of claim 1, wherein the gaskets comprises a composite of a material having a higher ratio of change in compressibility than the ratio of change in compressibility of a the gas diffusion layers and a material having a lower ratio of change in compressibility than the ratio of change in compressibility of the gas diffusion layers.

10. The fuel cell stack of claim 8, wherein a ratio of change in compressibility of the material of the gaskets having the higher ratio of change in compressibility is equal to or greater than about 1.7 times the ratio of change in compressibility of the gas diffusion layers.

11. The fuel cell stack of claim 8, wherein a ratio of change in compressibility of the material of the gaskets having the lower ratio of change in compressibility is equal to or less than about 0.3 times the ratio of change in compressibility of the gas diffusion layers.

12. The fuel cell stack of claim 8, wherein the material of the gaskets having the higher ratio of change in compressibility comprises at least one selected from the group consisting of Teflon®, polytetrafluoroethylene, carbon paper, carbon cloth, carbon felt, carbon fiber, glass fiber, Kapton®, polyimide, phenolic resin and acrylic resin.

13. The fuel cell stack of claim 8, wherein the material of the gaskets having the lower ratio of change in compressibility comprises at least one selected from the group consisting of ethylene propylene rubber, butyl rubber, silicon rubber and fluoro-rubber.

14. The fuel cell stack of claim 1, wherein the gaskets comprises a material identical to a material of the gas diffusion layers.

15. The fuel cell stack of claim 1, wherein the gaskets comprise:
a material with a sealing property; and
a material having a higher ratio of change in compressibility than the ratio of change in compressibility of the gas diffusion layers.

16. A fuel cell comprising
a supplier which supplies fuel and air;
a membrane electrode assembly comprising:
an electrolyte membrane-electrode including a first electrode, a second electrode, and an electrolyte membrane which is interposed between the first and second electrodes and contacts first surface of each of the first and second electrodes; and
a plurality of gas diffusion layers which are disposed in contact with a second surface of each of the first and second electrodes;
a plurality of plates which are disposed on a surface of the membrane electrode assembly; and
a plurality of gaskets which are disposed between the plates, wherein the gaskets contact the plates and surround the membrane electrode assembly,
wherein a ratio of change in compressibility of the gaskets is in a range from about 0.5 times a ratio of change in compressibility of the gas diffusion layers to about 1.5 times the ratio of change in compressibility of the gas diffusion layers at a same compressibility,
wherein a compressibility is a ratio of a reduced thickness with respect to an initial thickness, and
wherein the ratio of change in compressibility is defined by Equation 1 below:
Ratio of change in compressibility=ΔP/Δt, <Equation 1>
wherein ΔP denotes a pressure change, and Δt denotes a thickness change.

17. The fuel cell of claim 16, wherein the ratio of change in compressibility of the gaskets is about 0.7 the ratio of change in compressibility of the gas diffusion layers to about 1.3 times the ratio of change in compressibility of the gas diffusion layers.

18. The fuel cell of claim 16, wherein the compressibility of each of the gas diffusion layers and the gaskets is in a range from about 0.01 to about 0.5.

19. The fuel cell of claim 16, wherein
a thickness of the gaskets is reduced by a percentage in a range from about 1% to about 1.4% when a membrane thickness of the electrolyte membrane-electrode defined by Equation 2 below is reduced by a percentage of about 20%:
Membrane thickness of an electrolyte membrane-electrode (tₘ)=Thickness of a gasket (t_{g})−Thickness of a gas diffusion layer (t_{gdl}) <Equation 2>.

20. The fuel cell of claim 16, wherein
a pressure applied to the membrane electrode assembly is reduced by a percentage in a range from about 10% to about 22% when a membrane thickness of the electrolyte membrane-electrode defined by Equation 2 below is reduced by a percentage of about 20%:
Membrane thickness of an electrolyte membrane-electrode (tₘ)=Thickness of a gasket (t_{g})−Thickness of a gas diffusion layer (t_{gdl}) <Equation 2>.
